(19) United States
(12) Patent Application Publication
(10) Pub. No.: US 2023/0270099 A1
(43) Pub. Date: Aug. 31, 2023

(54) Animal Repellent Container

(71) Applicant: Andre Smith, Lagrange, NC (US)

(72) Inventor: Andre Smith, Lagrange, NC (US)

(21) Appl. No.: 17/682,518

(22) Filed: Feb. 28, 2022

(51) Int. Cl. A01M 29/12

(52) U.S. Cl. CPC A01M 29/12

(57) ABSTRACT

The animal repellent container has the capability of deterring deer through a soap capsule, and snakes via a moth ball bottom unit. The container is equipped with holes and hooks to enable simple installation and quick accessibility. The container also includes a top, bottom and expandable midsection compartment having a length based on a water absorption expansion and an evaporation contraction proportional to a respective increase and decrease in the number of holes exposed.

### BACKGROUND

Deer and snakes have always proved to be problematic for many gardeners, as they often ravage plants, leaving foliage raggedy and fruits plundered. In effort to manage the consequence of their presence, landowners tend to look for both an environmentally-friendly and effective means of deterring these animals, however, options are limited. There have been no products available as original equipment or as an aftermarket to address this problem.

An apparatus to prevent snakes, deer and other animals from eating fruits and vegetables in gardens is not being met by any known device or system at present. There have been no products available as original equipment or as an aftermarket to address this problem either.

### SUMMARY OF THE INVENTION

The main purpose of the Animal Repellent Container is to provide users with a deer and snake deterrent device for use in outdoor settings.

A container is disclosed herein comprising a top compartment configured to define a plurality of holes and to have a topside and an open bottom side. The container also includes a bottom compartment configured to define a plurality of holes and to have an open topside and a bottom side. A midsection is configured to define a number of holes between the top and the bottom compartments via an expansion based on a water absorption thereof; and a contraction of the midsection and a lesser number of holes based on a water evaporation thereof. A capsule contained in the top compartment exudes a greater scent based on a greater water content thereof relative to a smaller scent based on a smaller water content thereof.

### BRIEF DESCRIPTION OF THE DRAWINGS

FIG. 1 is an expanded perspective view of the Animal Repellent Container in accordance with an embodiment of the present disclosure.

FIG. 2 is a contracted perspective view of the Animal Repellent Container in accordance with an embodiment of the present disclosure

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

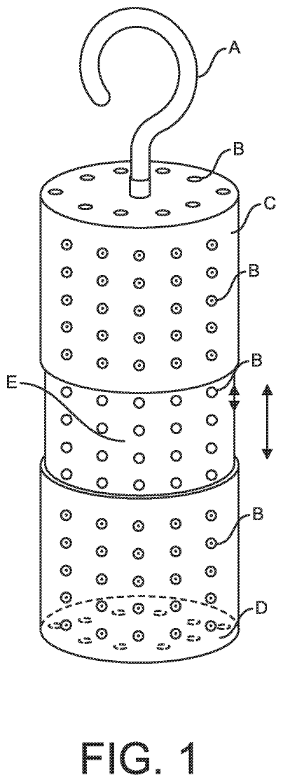

FIG. 1 is an expanded perspective view of the Animal Repellent Container showing: A referenced as hook, B referenced as holes, C referenced as weather proof soap capsule, D referenced as moth ball bottom, in accordance with an embodiment of the present disclosure. A midsection E is configured to join the compartments and to define a number of holes between the top and the bottom compartments via an expansion based on a water absorption thereof, and a contraction of the midsection and a lesser number of holes based on a water evaporation thereof.

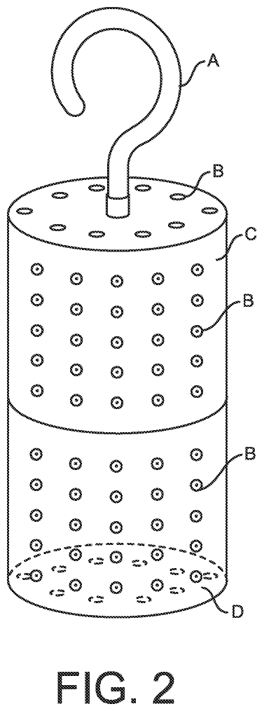

FIG. 2 is a contracted perspective view of the Animal Repellent Container showing: A referenced as hook, B referenced as holes, C referenced as weather proof soap capsule, D referenced as moth ball bottom, in accordance with an embodiment of the present disclosure.

The present disclosed Animal Repellent Container, also known as “Lawn Care Device” offers an eco-friendly, safe, and effective method of deterring both deer and snakes from gardens thus serving as a means to protect crops and lawn aesthetics. Expanding on the initial design of an average capsule, the lawn care device introduces a novel device with an upper soap compartment for a soap capsule that discourages feeding for deer, and a bottom moth ball compartment for a moth ball that effectively repels snakes. Users simply place this cutting-edge product into flower beds positioned on their property, and once direct water or rain drops fall onto the device, the scent of Irish springs will diffuse allowing the aroma to ward off said animals. The lawn care device offers an efficacious means of both deer and snake proofing a lawn and/or garden.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. A container comprising:
a top compartment configured to define a plurality of holes in rows and columns and to have a topside and an open bottom side;
a bottom compartment configured to define a plurality of holes in rows and columns matching the top compartment rows and columns and to have an open topside and a bottom side; and
a midsection configured to join the top and the bottom compartments and to define a number of holes in rows and columns configured to line up with the plurality of holes of the top and bottom compartments via an expansion of the midsection based on a water absorption thereof,
wherein a contraction of the midsection underlays the holes of the rows and columns of the top and matching bottom compartments onto the midsection holes and decreases the number of holes exposed based on a water evaporation thereof.

2. The container of claim 1, further comprising a capsule contained in the top compartment configured to exude a greater scent based on a greater water content thereof relative to a smaller scent based on a smaller water content thereof.

3. The container of claim 1, further comprising a capsule contained in the bottom compartment configured to exude a larger scent based on a larger water content thereof relative to a smaller scent based on a smaller water content thereof.

4. The container of claim 1 further comprising a gravity attachment on a topside of the top compartment and configured to attach to a branch of a tree and bush.

5. The container of claim 1, wherein the water absorption of the midsection expands a length of the midsection between the top and the bottom compartments and increases the number of holes.

6. The container of claim 1, wherein the number of holes is greater based on a length expansion of the midsection based on the water absorption.

7. The container of claim 1, wherein the number of holes is less based on a length contraction of the midsection based on the water evaporation of a capsule therein.

8. The container of claim 1, further comprising a soap capsule contained within the top compartment configured to activate an animal deterrent scent upon a water exposure via the number of holes.

9. The container of claim 1, further comprising a moth ball contained with the bottom compartment configured to activate an animal deterrent scent upon a water exposure via the number of holes.

10. The container of claim 1, further comprising a rate of contraction of the capsule midsection proportional to a rate of water evaporation therefrom.

11. The container of claim 1, further comprising a rate of expansion of the midsection proportional to a rate of water absorption thereof.

12. The container of claim 1, further comprising a rate of scent exuded from a capsule in the top compartment proportional to a rate of water absorption thereof.

13. The container of claim 1, further comprising a rate of scent exuded from a capsule in the bottom compartment proportional to a rate of water absorption thereof.

14. The container of claim 1, wherein a rate of water evaporation of the midsection is constant depending on a rate of length expansion thereof based on the water absorption.

15. The container of claim 1, wherein a rate of water absorption of the midsection is constant depending on a rate of length contraction thereof based on the water evaporation.

16. The container of claim 1, wherein an exposed number of holes in the midsection is based on a length expansion of the midsection via the water absorption thereof.

17. The container of claim 1, wherein an exposed number of holes in the midsection is based on a length contraction of the midsection via the water evaporation.

18. The container of claim 1, wherein an exposed number of holes in the midsection is greater based on the water absorption thereof relative to a covered plurality of holes by the top and the bottom compartments based on the water evaporation thereof.
